(19) United States
(12) Patent Application Publication
(10) Pub. No.: US 2019/0052476 A1
(43) Pub. Date: Feb. 14, 2019

(54) SMART APPLIANCE CONTROL METHOD AND SMART APPLIANCE

(71) Applicant: QINGDAO HAIER WASHING MACHINE CO., LTD., Shandong (CN)

(72) Inventors: Hai SHU, Shandong (CN); Zhanxing HUANG, Shandong (CN); Sheng XU, Shendong (CN); Yan LI, Shandong (CN); Junming YIN, Shandong (CN)

(21) Appl. No.: 16/073,302

(22) PCT Filed: Jan. 25, 2017
(86) PCT No.: PCT/CN2017/072564

§ 371 Date: Jul. 26, 2018

(30) Foreign Application Priority Data
Jan. 26, 2016 (CN) 201610051917.3

(51) Int. Cl. H04L 12/28; H04W 84/12; H04W 12/04; H04W 12/06

(52) U.S. Cl. CPC H04L 12/283; H04W 84/12; H04L 2012/2841; H04W 12/06; H04L 2012/285; H04W 12/04

(57) ABSTRACT

Provided are a smart appliance control method and a smart appliance. The smart appliance control method, applied to a smart terminal, includes: providing an operating program having a WiFi module setting interface on the smart terminal, the smart terminal is communicatively connected to the smart appliance through a communication module; and entering the WiFi module setting interface through the operating program of the smart terminal, selecting a searched router signal, inputting a router password, and configuring a WiFi module of the smart appliance to connect to a router.

### TECHNICAL FIELD

The present disclosure relates to the technical field of wireless networks, and for example, relates to a smart appliance control method and a smart appliance.

### BACKGROUND

With the development of communication network technologies and the continuous improvement of requirements of people for household products, people pay more and more attention to Internet of things smart appliances. The design and development of the Internet of things smart appliances are no longer limited to the experimental research and development stage. A variety of smart appliances have begun to enter the market on a small scale, and begin to be used by social ordinary users.

A widely used control mode for the smart appliance in a related art is to control the smart appliance through a smart terminal. The smart terminal is additionally equipped with a wireless communication module to achieve communication between the smart terminal and an Internet, so that remote control over the smart appliance may be achieved by installing an Application (app) client on a terminal device (such as a mobile phone, a Portable Android Device (pad) and a Personal Computer (PC)). A first step for achieving the remote control over the smart appliance is to connect the smart appliance to a network. However, most of mainstream smart appliances in the art are in a digital tube displaying mode, and are not provided with touch screens, so that a Wireless Fidelity (WiFi) module of the smart appliance may not be directly configured on a smart appliance operation panel to connect to a router. The WiFi module is generally required to be configured to enter a hotspot mode and then is connected to the WiFi of a washing machine through the smart terminal. A router password is indirectly sent to the WiFi module. Then, the WiFi module is restarted to connect to the router. Such operation leads to complicated steps, low configuration success rate and poor user experience.

### SUMMARY

The present disclosure provides a smart appliance control method and a smart appliance, so as to solve problems of complicated operation, low configuration success rate and poor user experience in a smart appliance networking process in the related art.

An embodiment of the present disclosure provides a smart appliance control method, applied to a smart terminal, including:

providing an operating program having a Wireless-Fidelity (WiFi) module setting interface on the smart terminal, the smart terminal is communicatively connected to a smart appliance through communication modules; and

entering the WiFi module setting interface through the operating program of the smart terminal, selecting a searched router signal, inputting a router password, and configuring a WiFi module of the smart appliance to connect to a router.

Optionally, in a step of providing the operating program having the WiFi module setting interface on the smart terminal, the smart terminal is communicatively connected to the smart appliance through the communication modules, the communication modules are Bluetooth modules respectively arranged on the smart appliance and the smart terminal.

Optionally, during the step of providing the operating program having the WiFi module setting interface on the smart terminal, the smart terminal is communicatively connected to the smart appliance through the communication modules, error information is displayed on the smart terminal when the smart terminal fails to normally connect to the smart appliance through the communication modules.

Optionally, the step of providing the operating program having the WiFi module setting interface on the smart terminal, the smart terminal is communicatively connected to the smart appliance through the communication modules, further includes: providing a communication module start key on a control panel of the smart appliance, and starting the communication module of the smart appliance through the communication module start key.

Optionally, a step of entering the WiFi module setting interface through the operating program of the smart terminal, selecting the searched router signal, inputting the router password, and configuring the WiFi module of the smart appliance to connect to the router further includes: controlling and viewing an operation state of the smart appliance through the operating program by the smart terminal.

Optionally, the method further includes: performing data interaction with the smart appliance through a server by the smart terminal.

Optionally, the step of performing the data interaction with the smart appliance through the server by the smart terminal includes:

registering the smart terminal in the server, and binding an account registered in the smart terminal with the smart appliance; and

sending control information to the corresponding smart appliance through the server by the smart terminal, and receiving data information sent by the smart appliance through the server by the smart terminal.

Optionally, in the step of entering the WiFi module setting interface through the operating program of the smart terminal, selecting the searched router signal, inputting the router password, and configuring the WiFi module of the smart appliance to connect to the router, error information is displayed on the smart terminal when the WiFi module fails to connect to the router.

An embodiment of the present disclosure further provides a smart appliance control method, applied to a smart appliance, including:

establishing communicative connection with a smart terminal through a communication module, where the smart appliance is provided with a Wireless-Fidelity (WiFi) module and the communication module;

sending a router Service Set Identifier (SSID) list searched by the WiFi module to the smart terminal;

receiving a SSID and a password of a router selected by the smart terminal; and

connecting the WiFi module to the selected router.

Optionally, the communication module is a Bluetooth module configured on the smart appliance.

Optionally, the Bluetooth module and the WiFi module of the smart appliance are integrated.

Optionally, a step of establishing communicative connection with the smart terminal through the communication module includes:

providing a communication module start key on a control panel of the smart appliance, and starting the communication module of the smart appliance through the communication module start key.

Optionally, a smart appliance control method, applied to a smart appliance, further including: performing data interaction by the smart appliance and the smart terminal through a server.

Optionally, a step of performing the data interaction between the smart appliance and the smart terminal through the server includes:

binding the smart appliance to an account registered by the smart terminal; and

sending, by the smart appliance, data information to the corresponding smart terminal through the server.

An embodiment of the present disclosure further provides a smart appliance, including a Wireless Fidelity (WiFi) module, a communication module and a control panel. Optionally, a communication module start key is provided on the control panel. The communication module of the smart appliance is started through communication module the start key.

Optionally, the communication module is a Bluetooth module.

Optionally, the WIFI module and the Bluetooth module are integrated.

Optionally, the smart appliance is a washing machine.

According to embodiments of the present disclosure, through direct connection between the smart appliance and the smart terminal, on the smart terminal, inputting of the router password may be achieved. The WiFi module of the smart appliance does not need to enter a hotspot mode, so that the smart appliance networking operation is simplified, and the configuration success rate is high, thereby enhancing the use experience of a user.

### BRIEF DESCRIPTION OF DRAWINGS

FIG. 1 is a flow chart illustrating control over a smart appliance provided by the present embodiment;

FIG. 2 is a schematic diagram illustrating control over a smart appliance provided by the present embodiment;

FIG. 3 is a structural diagram illustrating a washing machine provided by the present embodiment;

FIG. 4 is a flow chart illustrating control over a washing machine provided by the present embodiment; and

FIG. 5 is a diagram illustrating hardware structures of a smart terminal provided by the present embodiment.

### DETAILED DESCRIPTION

Technical solutions of the present disclosure are described below through optional embodiments in combination with drawings. Embodiments and features in embodiments can be arbitrarily combined with each other without conflicts.

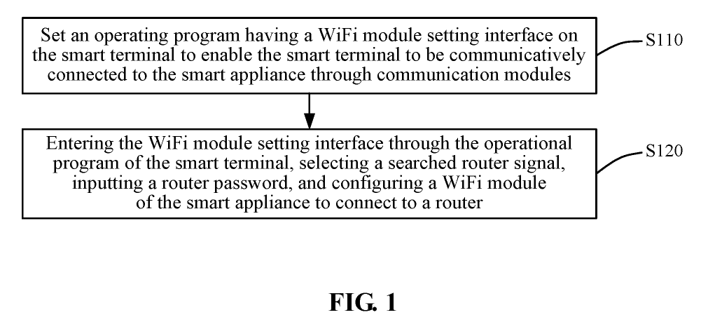

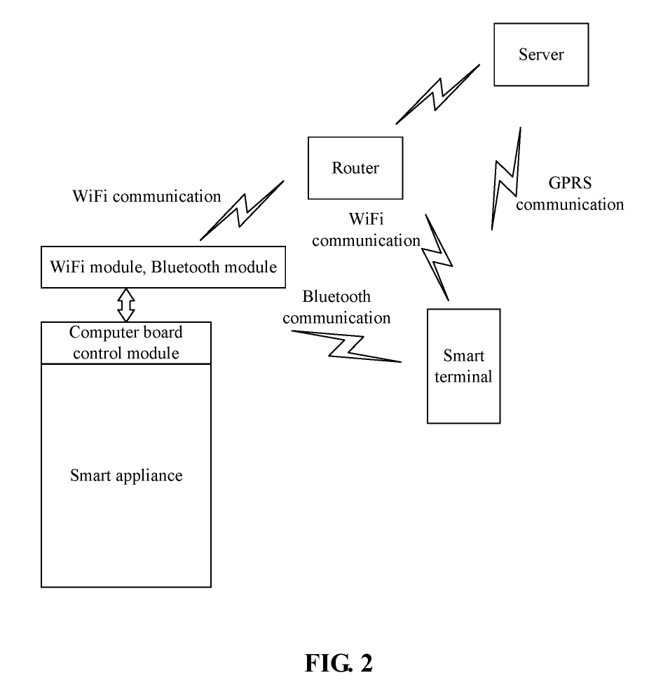

As shown in FIG. 1 and FIG. 2, the present embodiment provides a smart appliance control method, including:

step S110, providing an operating program having a wireless-fidelity (WiFi) module setting interface on a smart terminal, the smart terminal is communicatively connected to a smart appliance through communication modules; and

step S120, entering the WiFi module setting interface through the operating program of the smart terminal, selecting a searched router signal, inputting a router password is input, and configuring a WiFi module of the smart appliance to connect to a router.

Through the above method, a direct connection between the smart appliance and the smart terminal may be achieved, and the inputting of a router password may be achieved on the smart terminal. The WiFi module of the smart appliance does not need to enter a hotspot mode, so that the smart appliance networking operation is simplified, and the configuration success rate is high, thereby enhancing the use experience of a user.

Optionally, in the step S110, the communication modules are Bluetooth modules respectively arranged on the smart appliance and the smart terminal. The Bluetooth modules are commonly used modules which are good in communication stability and low in use cost.

The Bluetooth module and the WiFi module arranged on the smart appliance are integrated. Of course, both of the Bluetooth module and the WiFi module may be two independently arranged modules.

In the step S110, error information is displayed on the smart terminal when the smart terminal fails to normally connect to the smart appliance through the communication modules. In this way, the user may intuitively determine whether the smart appliance and the smart terminal are in normal communication states.

In the step S110, a communication module start key is provided on a control panel of the smart appliance, and the communication module of the smart appliance is started through the communication module start key. The start key is a single key or a combined key of one or more keys. The Bluetooth module of the smart appliance may be set in a pairing state by clicking the single key or the combined key. The Bluetooth of the smart terminal is turned on to achieve a pairing connection between the Bluetooth of the smart terminal and the Bluetooth of the smart appliance.

The step S120 further includes: controlling and viewing an operation state of the smart appliance through the operating program by the smart terminal. That is, the smart terminal and the smart appliance may be directly interconnected, so that the user may also remotely operate the router without the router.

The smart appliance control method further includes a step S130: performing data interaction with the smart appliance through a server by the smart terminal.

Optionally, the smart terminal performs a registration in the server, and an account registered by the smart terminal is bound to the smart appliance; and

the smart terminal sends control information to the corresponding smart appliance through the server, and the smart appliance sends data information to the corresponding smart terminal through the server.

Optionally, the smart appliance includes a computer board controller. The Bluetooth modules and the WiFi module are communicatively connected to the computer board controller. The computer board controller is used for controlling operation of the smart appliance, and the computer board controller is connected to Internet through the WiFi module and communicates with the server. The server provides appliance management platform services including registering and managing a user account, binding and managing the smart appliance and the user account, sending a control command to the smart appliance, receiving information reported by the smart appliance, and the like. The user may register an account in a website address of a server to manage own appliances.

In step S120, error information is displayed on the smart terminal when the WiFi module fails to connect to the router. Therefore, the user may more intuitively determine whether the smart appliance is networked successfully or not.

In the present embodiment, the smart terminal may be a mobile device such as a smart phone or a tablet personal computer.

The smart appliance may be commonly used appliances for the user, such as the washing machine, an air conditioner, a water heater and a refrigerator.

In present embodiment, a smart appliance is further provided, including a Wireless Fidelity (WiFi) module, a communication module and a control panel.

Optionally, a communication module start key is provided on the control panel. The communication module of the smart appliance is started through the communication module start key.

Optionally, the communication module is a Bluetooth module.

Optionally, the WIFI module and the Bluetooth module are integrated.

Optionally, the smart appliance is a washing machine.

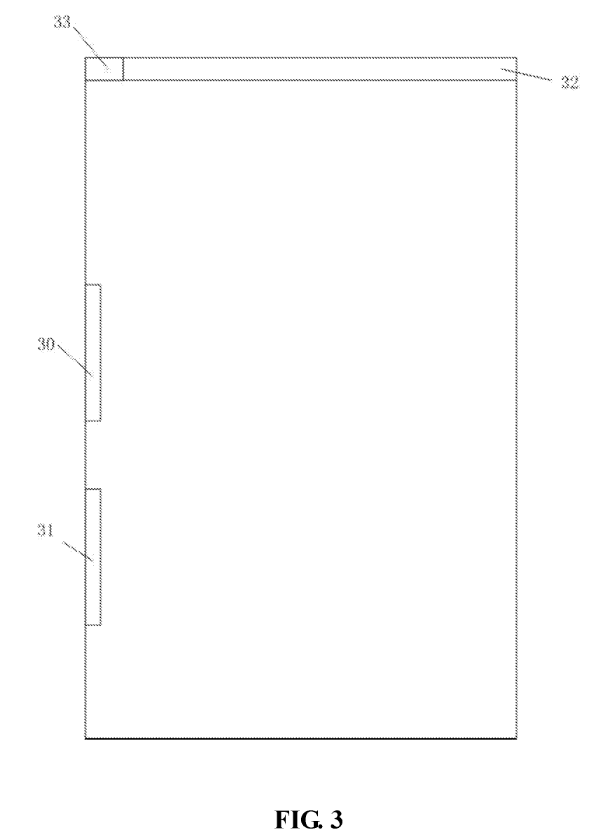

In present embodiment, a washing machine is further provided, as shown in FIG. 3, including: a WiFi module 30, a communication module 31 and a control panel 32.

Optionally, a communication module start key 33 is provided on the control panel 32 of the washing machine. The communication module 31 of the washing machine is started through the communication module start key.

Optionally, the communication module 31 is a Bluetooth module.

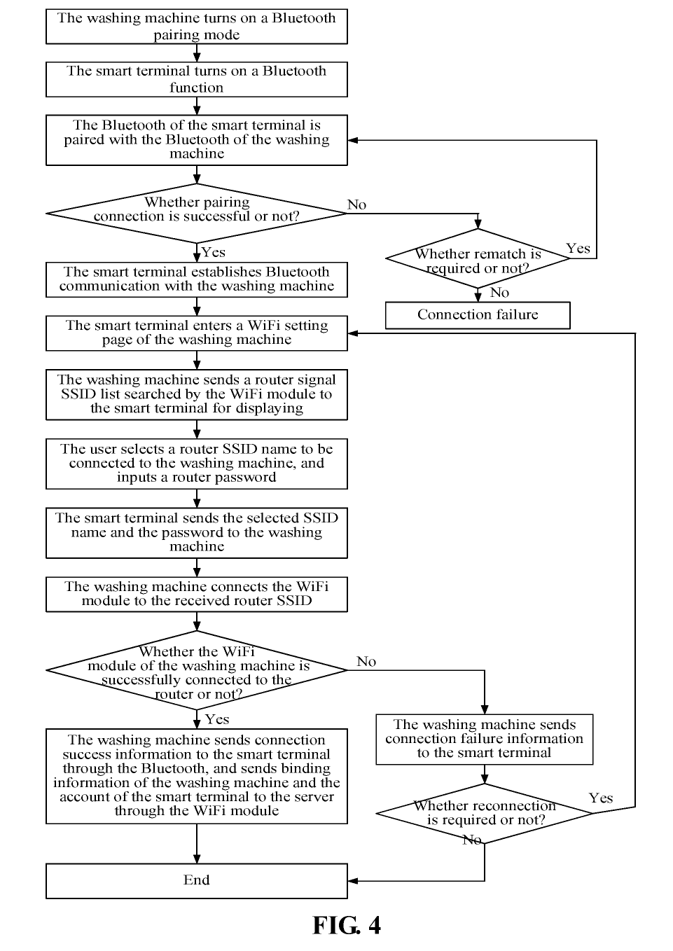

As shown in FIG. 4, the present embodiment further describes the above-mentioned smart appliance control method by taking the washing machine as an example:

Firstly, Bluetooth modules of the washing machine and the smart terminal are respectively turned on, and the two Bluetooth modules paired through Bluetooth. Entering into a WiFi setting page of an operating program of the smart terminal when the two Bluetooth modules are paired successfully. Whether to pair the two Bluetooth modules or not again is inquired when the two Bluetooth modules are not paired successfully. The two Bluetooth modules are paired again when a rematch feedback is acquired after rematch or not is inquired. Connection failure is prompted when no rematch feedback is acquired.

After entering into the WiFi setting page of the operating program, the washing machine sends a router signal Service Set Identifier (SSID) list searched by the WiFi module to the smart terminal for displaying. The user selects a router SSID name to be connected to the washing machine, and inputs a router password. The smart terminal sends the selected SSID name and the password to the washing machine. The washing machine connects the WIFI module to a received router SSID, and judges whether the connection to a router is successful or not. In case of successful connection, the washing machine feeds back connection success information to the smart terminal through the Bluetooth, and sends binding information of the washing machine and the account of the smart terminal to the server through the WiFi module. In case of failed connection, the washing machine feeds back connection failure information to the smart terminal, and inquires whether reconnection is required or not. Reentering the WiFi setting interface when a reconnection feedback is acquired. The operation is ended when no reconnection feedback is acquired.

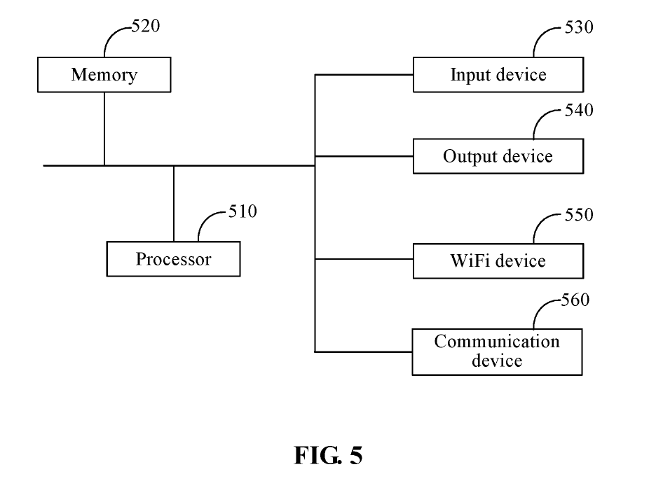

The present embodiment further provides a diagram illustrating hardware structures of a smart terminal, as shown in FIG. 5, including:

one or more processors 510 and a memory 520. In FIG. 5, one processor 510 is taken as an example.

The smart terminal may further include: an input device 530, an output device 540, a WiFi device 550 and a communication device 560.

The processor 510, the memory 520, the input device 530, the output device 540, the WiFi device 550 and the communication device 560 may be connected through a bus or in other ways. In FIG. 5, connection through the bus is taken as an example.

As a non-transitory computer readable memory medium, the memory 520 may be used for storing non-transitory software programs, non-transitory computer executable programs and modules, such as program instructions/modules corresponding to the smart appliance control method in embodiments of the present application. The processor 510 operates the non-transitory software programs, the instructions and the modules which are stored in the memory 520 to execute various types of function applications and data processing of the server, thereby achieving the smart appliance control method of above method embodiments.

The memory 520 may include a program storing region and a data storing region. The program storing region may store an operating system and an application program required by at least one function. The data storing region may store data created by use of a terminal interacting with the application program. In addition, the memory 520 may include a high-speed random access memory, and further may include a non-transitory memory, for example, at least one disk memory, a flash memory, or other non-transitory solid-state memories. In some embodiments, the memory 520 may optionally include memories remotely arranged relative to the processor 510. These remote memories may be connected, through networks, to the terminal that interacts with the application program.

Examples of the above-mentioned networks include, but not limited to, the Internet, an Intranet, a local area network, a mobile communication network and a combination thereof.

The input device 530 may receive input digital or character information, and generate key signal input related to user settings and functional control of the terminal that interacts with the application program. The output device 540 may include a display device such as a display screen.

The one or more modules are stored in the memory 520. The smart appliance control method in any of the method embodiments is executed when the one or more modules are executed by the one or more processors 510.

The smart terminal is communicatively connected to the smart appliance through the communication device 560.

Optionally, the communication device 560 may be a Bluetooth module.

The smart terminal is connected to the router through the WiFi device 550.

The above-mentioned product may execute the method provided by embodiments of the present application, and has corresponding functional modules for executing the method and beneficial effects. See the method provided by embodiments of the present application for technical details not described in detail in the present embodiment.

The above describes the technical principle of the present disclosure in combination with optional embodiments. These descriptions are only used for explaining the principle of the present disclosure, but may not be explained as limitations to the protection scope of the present disclosure in any way.

### INDUSTRIAL PRACTICABILITY

Embodiments of the present disclosure provide a smart appliance control method and a smart appliance. Through the direct connection between the smart appliance and the smart terminal, on the smart terminal, inputting of the router password may be achieved. The WiFi module of the smart appliance does not need to enter the hotspot mode, so that the smart appliance networking operation is simplified, and the configuration success rate is high, thereby enhancing the use experience of the user.

What is claimed is:

1. A smart appliance control method, applied to a smart terminal, comprising:
providing an operating program having a Wireless-Fidelity (WiFi) module setting interface on the smart terminal, wherein the smart terminal is communicatively connected to a smart appliance through communication modules; and
entering the WiFi module setting interface through the operating program of the smart terminal, selecting a searched router signal, inputting a router password, and configuring a WiFi module of the smart appliance to connect to a router.

2. The smart appliance control method according to claim 1, wherein in the providing the operating program having the WiFi module setting interface on the smart terminal, the smart terminal is communicatively connected to the smart appliance through the communication modules, wherein the communication modules comprise Bluetooth modules respectively arranged on the smart appliance and the smart terminal.

3. The smart appliance control method according to claim 1, wherein during the providing the operating program having the WiFi module setting interface on the smart terminal, the smart terminal is communicatively connected to the smart appliance through the communication modules, and error information on the smart terminal when the smart terminal fails to normally connect to the smart appliance through the communication modules.

4. The smart appliance control method according to claim 1, wherein the providing the operating program having the WiFi module setting interface on the smart terminal, and the smart terminal is communicatively connected to the smart appliance through the communication modules, further comprises:
providing a communication module start key on a control panel of the smart appliance, and starting the communication modules of the smart appliance through the communication module start key.

5. The smart appliance control method according to claim 1, wherein the entering the WiFi module setting interface through the operating program of the smart terminal, selecting the searched router signal, inputting the router password, and configuring the WiFi module of the smart appliance to connect to the router, further comprises:
controlling and viewing an operation state of the smart appliance through the operating program by the smart terminal.

6. The smart appliance control method according to claim 1, wherein the method further comprises:
performing data interaction with the smart appliance through a server by the smart terminal.

7. The smart appliance control method according to claim 6, wherein the performing the data interaction with the smart appliance through the server by the smart terminal comprises:
registering the smart terminal in the server, and binding an account registered to the smart terminal with the smart appliance; and
sending control information to the smart appliance through the server by the smart terminal, and receiving data information sent by the smart appliance through the server by the smart terminal.

8. The smart appliance control method according to claim 1, wherein during the entering the WiFi module setting interface through the operating program of the smart terminal, selecting the searched router signal, inputting the router password, and configuring the WiFi module of the smart appliance to connect to the router, error information on the smart terminal when the WiFi module fails to connect to the router.

9. A smart appliance control method, applied to a smart appliance, comprising:
establishing communicative connection with a smart terminal through a communication module, wherein the smart appliance is provided with a Wireless-Fidelity (WiFi) module and the communication module;
sending a router Service Set Identifier (SSID) list searched by the WiFi module to the smart terminal;
receiving an SSID and a password of a router selected by the smart terminal; and connecting the WiFi module to the selected router.

10. The smart appliance control method according to claim 9, wherein the communication module comprises a Bluetooth module configured on the smart appliance.

11. The smart appliance control method according to claim 10, wherein the Bluetooth module and the WiFi module of the smart appliance are integrated.

12. The smart appliance control method according to claim 9, wherein the establishing communicative connection with the smart terminal through the communication module comprises:
providing a communication module start key on a control panel of the smart appliance, and starting the communication module of the smart appliance through the communication module start key.

13. The smart appliance control method according to claim 9, wherein the smart appliance control method further comprises: performing data interaction between the smart appliance and the smart terminal through a server.

14. The smart appliance control method according to claim 13, wherein the performing the data interaction between the smart appliance and the smart terminal through the server comprises:
binding the smart appliance to an account registered by the smart terminal; and sending data information to the smart terminal through the server by the smart appliance.

15. A smart appliance, comprising a Wireless Fidelity (WiFi) module, a communication module and a control panel.

16. The smart appliance according to claim 15, wherein the control panel includes a communication module start key, and the communication module of the smart appliance is configured to be started through the communication module start key.

17. The smart appliance according to claim 15, wherein the communication module comprises a Bluetooth module.

18. The smart appliance according to claim 17, wherein the WiFi module and the Bluetooth module are integrated.

19. The smart appliance according to claim 15, wherein the smart appliance is a washing machine.

20. The smart appliance control method according to claim 2, wherein during the providing the operating program having the WiFi module setting interface on the smart terminal, and the smart terminal is communicatively connected to the smart appliance through the communication modules,
error information is displayed on the smart terminal when the smart terminal fails to normally connect to the smart appliance through the communication modules.
